(19) United States
(12) Patent Application Publication
(10) Pub. No.: US 2003/0042728 A1
(43) Pub. Date: Mar. 6, 2003

(54) Structure of a file which can stand in an upright position

(76) Inventors: Chyun-Chau Lin, Taipei (TW); Chien-Hsun Wu, Taipei (TW)

Correspondence Address: Chyun-Chau Lin, PO Box 82-144, Taipei, TW

(21) Appl. No.: 10/014,423

(22) Filed: Dec. 14, 2001

(30) Foreign Application Priority Data
Aug. 29, 2001 (TW) 090214813

(51) Int. Cl. B42D 3/00

(52) U.S. Cl. 281/33

(57) ABSTRACT

The present invention relates an improved structure of a file which can stand in an upright position comprising (a) an outer covering board having a horizontal scored line across the center of the board so that the outer covering board is bendable outward along the scored line; (b) an inner covering board positioned at the side of the outer covering opposite to the direction of the outer covering being bent, and being mounted with a document clipping device; and (c) two thin boards mounted perpendicularly from the bottom edge of the outer covering board, proximate to the lower corners, to the bottom edge of the inner covering board, proximate to the bottom corners of the inner board, wherein the center of the thin boards are provided with a bending section, thereby when the lower section of the outer covering board is extended or bended outward and the two thin boards are fully extended, the file stands upright on a flat surface, and when the lower section of the outer covering board is retracted towards the inner covering board by bending the thin boards at the bending section, the file is folded for storage.

### BACKGROUND OF THE INVENTION

(a) Technical Field

The present invention relates to a file structure and in particular, a file which can in an upright position by having an outer covering board, an inner covering board mounted with a clip device, and a pair of thin board to extend and support the file structure when the file is opened.

(b) Description of the Prior Art

Conventional file for documentation is normally placed horizontally and cannot be placed in an upright position. This is not convenient in application when the filed documents are needed while using the computer. One of the hands is needed to hold the file so that the filed documents are in a position, which can be read by the user. In this case, the user can have only one hand to use the computer and at the same time another hand is used to hold the file. Accordingly, it is the object of the present invention to provide an improved structure of a file, which can stand in an upright position, facilitating the documentation of file and usage of the filed documents.

### SUMMARY OF THE INVENTION

Accordingly, it is an object of the present invention to provide an improved structure of a file, wherein the file can stand in an upright position, overcoming the drawback of the conventional file and facilitating data searching and browsing.

Yet another object of the present invention is to provide an improved structure of a file, wherein the inner covering board is mounted with clip device to fasten document.

A further object of the present invention is to provide an improved structure of a file, wherein the back, center of the inner covering board is provided with a scored line section.

Another object of the present invention is to provide an improved structure of a file, wherein the back, center of the inner covering board is provided with a scored line section.

As aspect of the present invention is to provide an improved structure of a file which can stand in an upright position comprising:

(a) an outer covering board having a horizontal scored line across the center of the board so that the outer covering board is bendable outward along the scored line;

(b) an inner covering board positioned at the side of the outer covering opposite to the direction of the outer covering being bent, and being mounted with a document clipping device; and

(c) two thin boards mounted perpendicularly from the bottom edge of the outer covering board, proximate to the lower corners, to the bottom edge of the inner covering board, proximate to the bottom corners of the inner board, wherein the center of the thin boards are provided with a bending section, thereby when the lower section of the outer covering board is extended or bended outward and the two thin boards are fully extended, the file stands upright on a flat surface, and when the lower section of the outer covering board is retracted towards the inner covering board by bending the thin boards at the bending section, the file is folded for storage.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing the retracting of the file in accordance with the present invention.

FIG. 2 is a schematic view showing the retracting of the file of another preferred embodiment in accordance with the present invention.

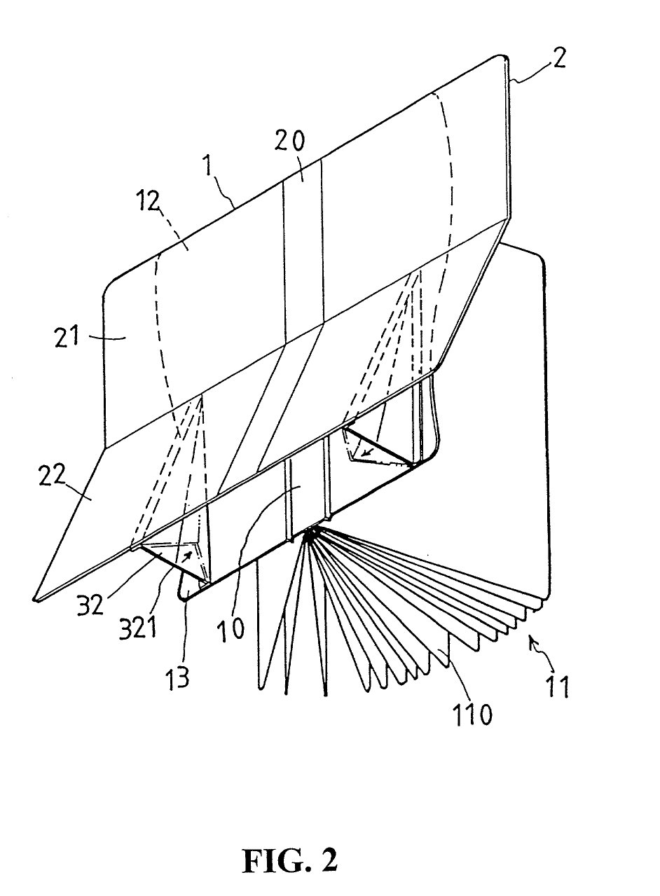

FIG. 3 is a perspective view showing the upright position of the file of FIG. 1 of the present invention.

FIG. 4 is a perspective view showing the tubular clip at center, rear side of the inner covering board in accordance with the present invention.

FIG. 5 is a perspective view showing the multiple-hole page clip at center, rear side of the inner covering board in accordance with the present invention.

FIG. 6 is a perspective view showing the arch-shaped clip at the inner covering board in accordance with the present invention.

FIG. 7 is a perspective view showing the multiple-hole page clip at the lateral board of the inner covering board in accordance with the present invention.

FIG. 8 is a perspective view showing the scored line at the rear of the inner covering board of the present invention.

FIG. 9 is a perspective view from another elevation of the file shown in FIG. 3.

FIG. 10 is a perspective view of the rear center of the outer covering board mounted with a scored line section in accordance with the present invention.

### DETAILED DESCRIPTION OF THE PRESENT INVENTION

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

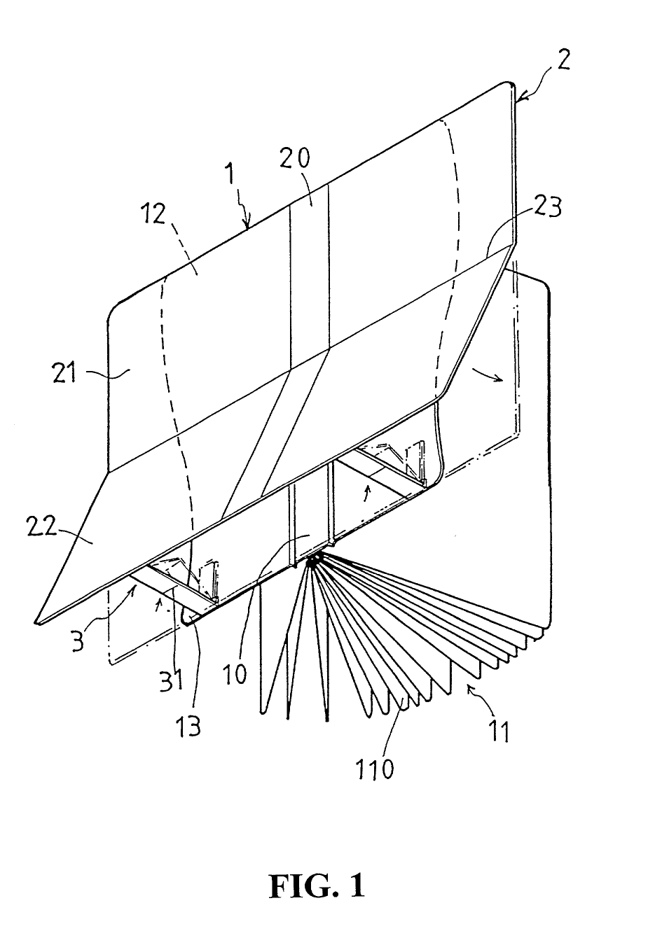

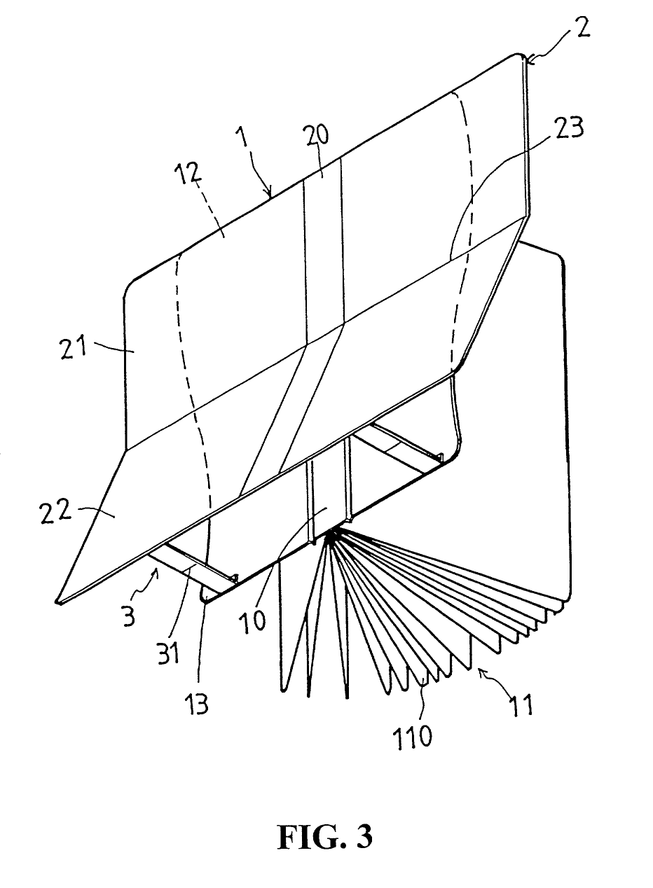

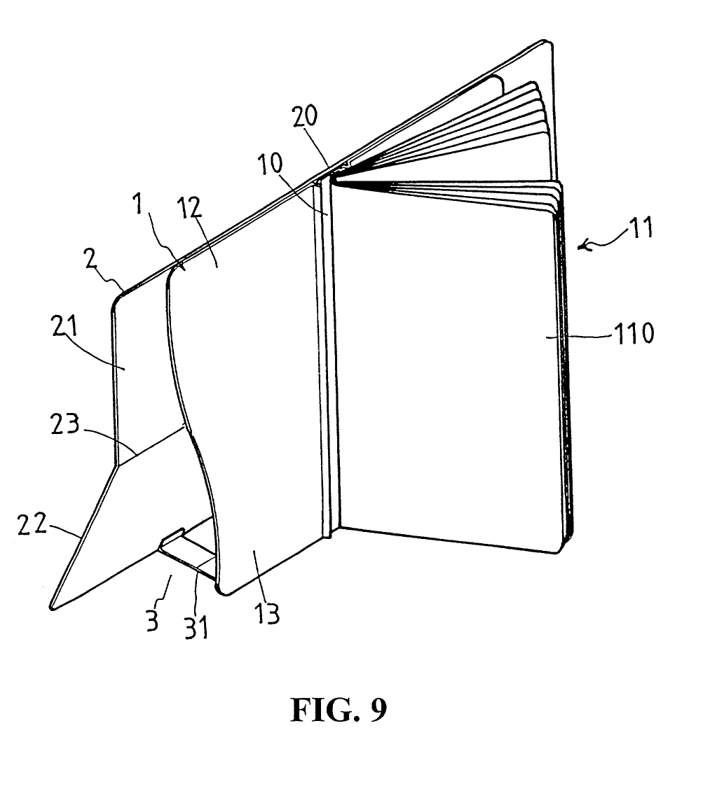

Referring to FIGS. 1, 3, and 9, there is shown an improved structure of a file comprising an inner covering board 1, an outer covering board 2, two thin boards 3. At the center of the rear surface 10 of the inner covering board 1, a clip device 11 is mounted and the outer covering board 2 is provided with a center rear section 20. The upper section 12 of the inner covering board 1 is mounted against the upper section 21 of the outer covering board 2. The edge at the bottom section 13 of the inner covering board 1 at the bottom corners is connected to the bottom edge of the outer covering board 2 by the thin boards 3. The thin board 3 is a “U” shaped structure and the center of the thin board 3 is a bending section 31 such that the thin board 3 can be folded at the bending section to form a W-shaped structure. When the thin boards 3 are folded and the inner pages 110 are stacked horizontally and the entire file can be laid horizontal for storage. To open the file such that the file can stand in an upright position, the lower section of the outer covering board 2 is extended outward and the two thin boards 3 are fully extended, at this instance, the file can be placed in an upright position. The clip device 11 mounted to the inner covering board 1 is used to clip documents.

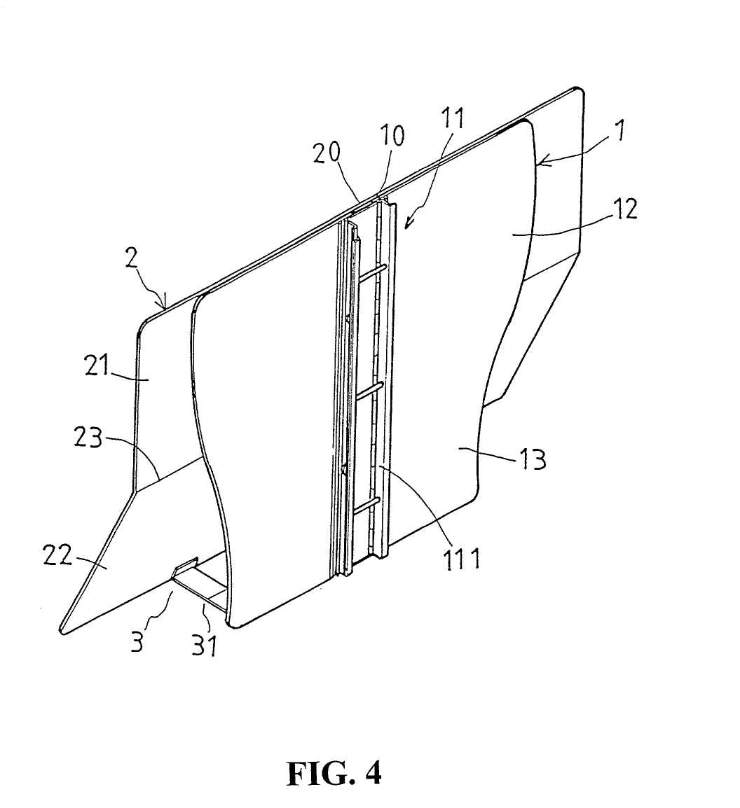

Referring to FIG. 4, there is shown another preferred embodiment of the improved structure of a file, which can stand in an upright position. In this preferred embodiment, the thin board 32 is made into a triangular fan shape, wherein the center of the inboard 32 has a bending section 321. If the file is to be retracted, the bending section 321 is pushed to one side and the bottom section 22 of the outer covering 2 is closed to the bottom section 13 of the inner covering board 1.

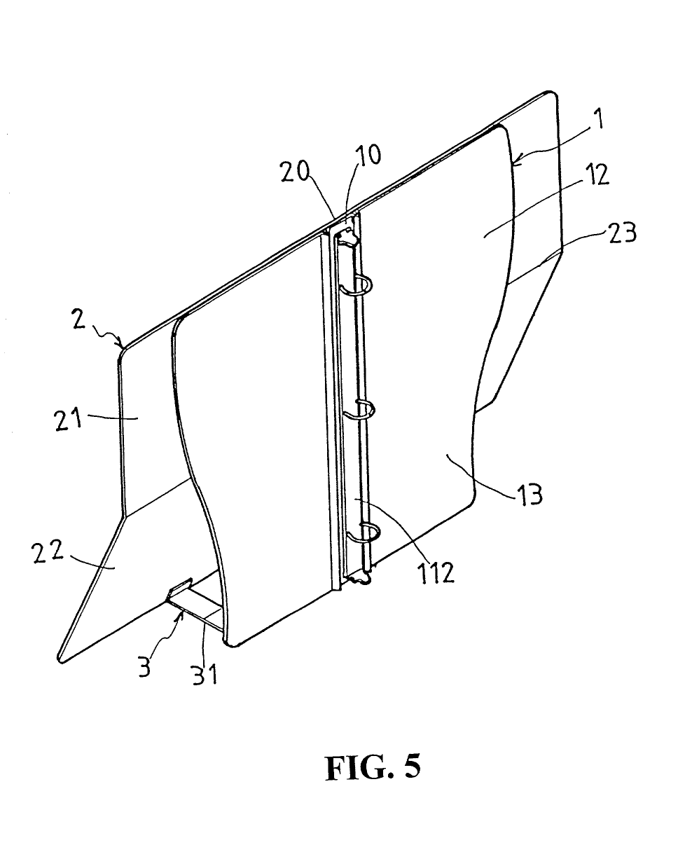

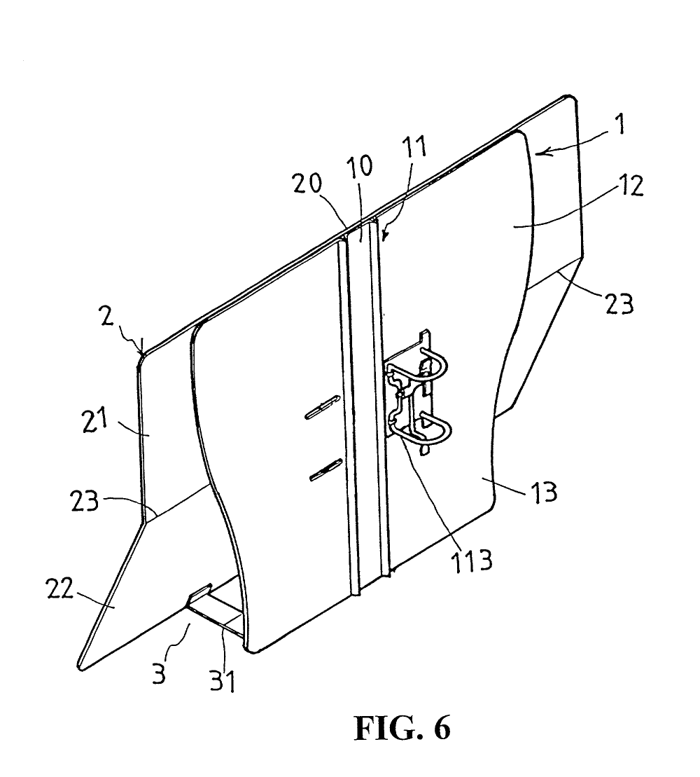

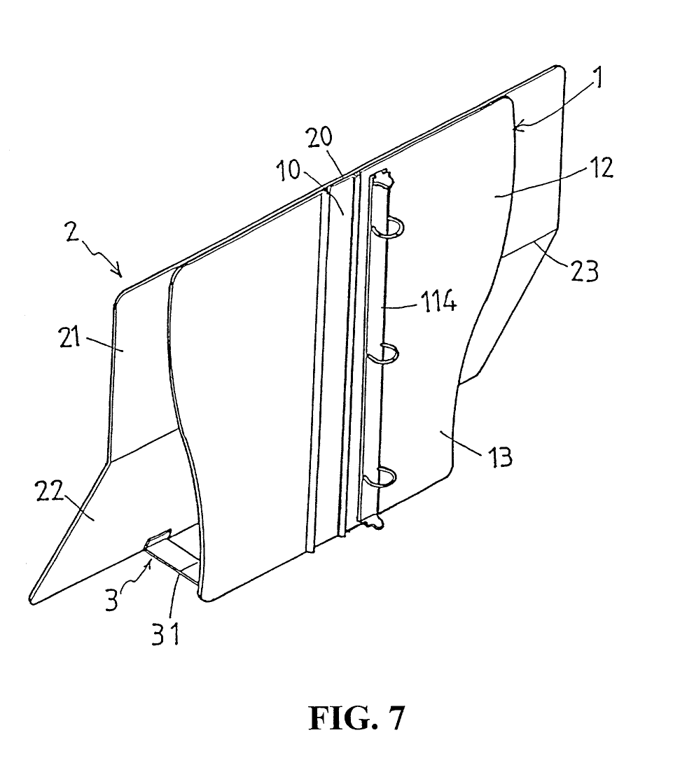

Referring to FIGS. 4, 5, 6, and 7, the clip device 11 can be replaced with a tubular clip (as shown in FIG. 4) or a multi-hole clip 112 (as shown in FIG. 5) or an arch-shaped clip 113 (as shown in FIG. 6) or a multiple-hole clip 114 located at the lateral side of the inner covering board 1 (as shown in FIG. 7).

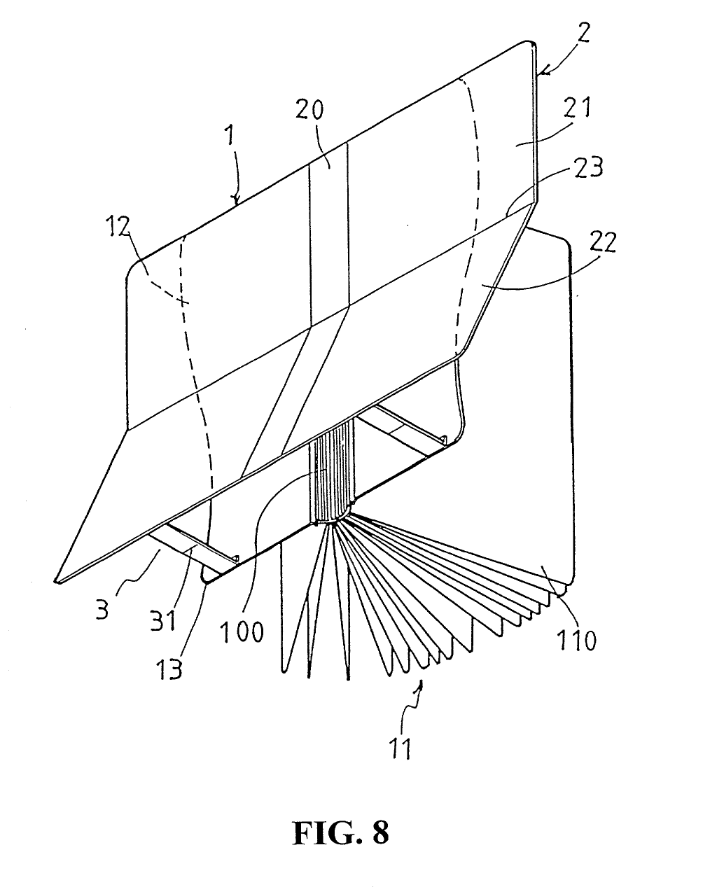

Referring to FIG. 8, the back center 10 of the inner covering board 1 is provided with a scored line section 100. This will facilitate the closing of the covering boards 1, 2.

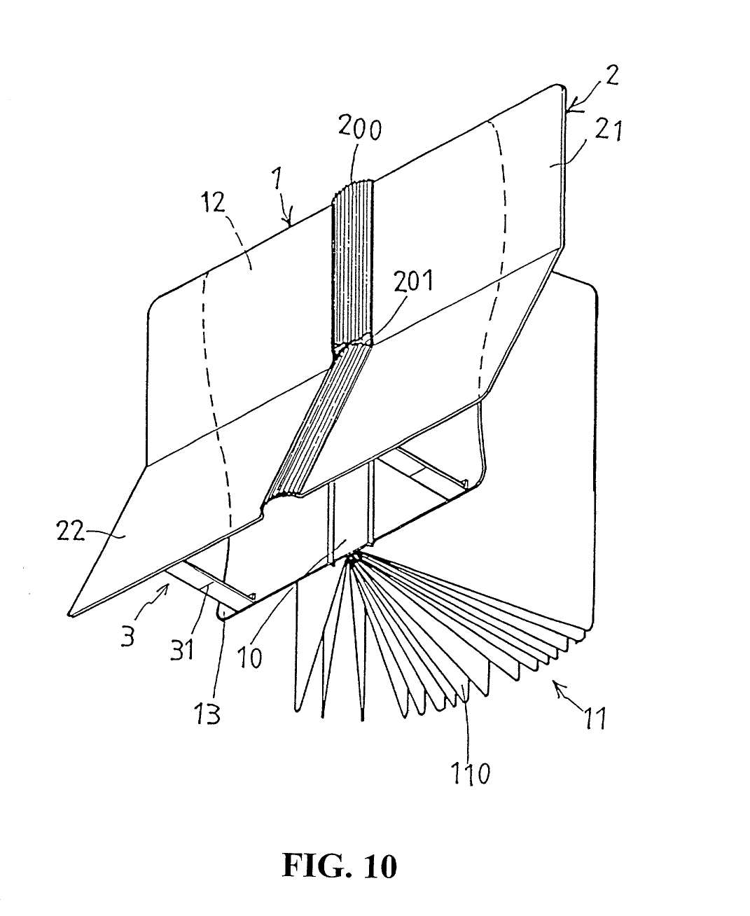

Referring to FIG. 10, there is a scored line section 200 with a plurality of holes 201 at the back center of the outer covering board 1. This will facilitate the lower section 22 of the outer covering board 2 from being pushed outward.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A structure of a file which can stand in an upright position comprising
(a) an outer covering board having a horizontal scored line across the center of the board so that the outer covering board is bendable outward along the scored line;
(b) an inner covering board positioned at the side of the outer covering opposite to the direction of the outer covering being bent, and being mounted with a document clipping device; and
(c) two thin boards mounted perpendicularly from the bottom edge of the outer covering board, proximate to the lower corners, to the bottom edge of the inner covering board, proximate to the bottom corners of the inner board, wherein the center of the thin boards are provided with a bending section, thereby when the lower section of the outer covering board is extended or bended outward and the two thin boards are fully extended, the file stands upright on a flat surface, and when the lower section of the outer covering board is retracted towards the inner covering board by bending the thin boards at the bending section, the file is folded for storage.

2. The structure of a file as set forth in claim 1, wherein the clip device mounted to the inner covering board is a plurality of pages to provide data file.

3. The structure of a file as set forth in claim 1, wherein the thin board has a “U” shape.

4. The structure of a file as set forth in claim 1, wherein the thin board is a triangular fan shaped.

5. The structure of a file as set forth in claim 1, wherein the clip device is a tubular fastener.

6. The structure of a file as set forth in claim 1, wherein the clip device is a multi-hole page clip.

7. The structure of a file as set forth in claim 1, wherein the clip device is an arch-shaped clip.

8. The structure of a file as set forth in claim 1, wherein the clip device is a plurality of file pockets.

9. The structure of a file as set forth in claim 2, wherein the back center of the outer covering board is provided with a scored line.
